(19) United States
(12) Patent Application Publication
(10) Pub. No.: US 2026/0009489 A1
(43) Pub. Date: Jan. 8, 2026

(54) ELECTRIC THERMAL INSULATION EQUIPMENT AND DISASTER PREVENTION AND WARNING SYSTEM THEREOF

(71) Applicant: DIRECTLY TECHNOLOGY CO., LTD., Hsinchu City (TW)

(72) Inventor: Shih-Hao TANG, Hsinchu City (TW)

(21) Appl. No.: 19/328,764

(22) Filed: Sep. 15, 2025

Related U.S. Application Data
(63) Continuation-in-part of application No. 17/722,686, filed on Apr. 18, 2022.

(51) Int. Cl. F16L 53/38; F16L 59/02; G05D 23/22

(52) U.S. Cl. CPC F16L 53/38; F16L 59/021; G05D 23/22

(57) ABSTRACT

An electric thermal insulation equipment comprising an electric thermal insulation system and a disaster prevention and warning system. The electric thermal insulation system supplements thermal energy to a pipeline and reduces outward dissipation of heat. The disaster prevention and warning system monitors the electric thermal insulation system to enhance safety and reliability. The electric thermal insulation system includes multiple electric thermal insulation units and corresponding temperature controllers, each temperature controller being electrically connected to a first electrical connector and a second electrical connector. The disaster prevention and warning system determines whether a temperature of each electric thermal insulation unit exceeds a first warning temperature value or whether a temperature of each first electrical connector exceeds a second warning temperature value, and generates a warning signal accordingly, thereby facilitating inspection and maintenance and preventing stoppage of the electric thermal insulation units.

This application is a Continuation-in-Part of U.S. Patent Application No. 17/722,686, filed on April 8, 2022, the disclosure of which is incorporated herein by reference in its entirety.

### FIELD OF THE INVENTION

The present invention relates to the field of electric thermal insulation, and more particularly to an electric thermal insulation equipment and a disaster prevention and warning system thereof. The electric thermal insulation equipment is configured to provide thermal insulation and heating to a pipeline for conveying materials.

### BACKGROUND OF THE INVENTION

In industrial production processes, pipelines used to convey specific products often require thermal insulation so that the pipelines can be maintained within a prescribed temperature range. This prevents deposition of the conveyed products inside the pipelines and avoids blockage thereof. In addition to insulation measures that reduce the rate of thermal energy dissipation, timely replenishment of the dissipated thermal energy is essential for maintaining the target temperature of the pipelines. To satisfy this requirement, heaters capable of enclosing the pipelines have been developed.

### SUMMARY OF THE INVENTION

A conventional heater comprises a heat insulation structure and an electric heating structure. The heat insulation structure is made of a material possessing heat-insulating properties, while the electric heating structure is disposed on one side of the heat insulation structure. When the heater is mounted around an outer periphery of a pipeline, the electric heating structure is positioned between the heat insulation structure and the pipeline. The electric heating structure provides thermal energy to the pipeline to replenish dissipated heat, and the heat insulation structure reduces outward thermal dissipation from both the pipeline and the electric heating structure.

Depending on the shape and length of the pipeline, dozens or even hundreds of heaters may be arranged along the pipeline, thereby forming an electric thermal insulation system. The electric thermal insulation system comprises a plurality of heaters and a plurality of temperature controllers. Each temperature controller is electrically coupled to a corresponding heater, and each temperature controller controls the operation of the electric heating structure of its associated heater. Each temperature controller is further electrically connected to a first electrical connector and a second electrical connector. The first electrical connector and the second electrical connector are engaged in a male-female configuration, and each first electrical connector is electrically connected to an adjacent second electrical connector, so that the plurality of temperature controllers is connected in series. Current is thus supplied through the first electrical connectors and the second electrical connectors to each of the temperature controllers and each of the heaters.

Each temperature controller regulates the current supplied to its corresponding heater, thereby controlling the thermal energy generated by the electric heating structure. When the temperature of a heater exceeds a preset value, the corresponding temperature controller activates an overheat cut-off mechanism to interrupt power supply to the heater, thus preventing combustion or fire hazards in the heater and the pipeline.

However, once power supply to the heater is interrupted, the pipeline is deprived of thermal energy replenishment, causing the internal temperature of the pipeline to gradually decrease. As a result, the products conveyed through the pipeline are prone to deposition or blockage, thereby impairing subsequent processing operations. In some circumstances, the pipeline must be dismantled to remove deposited materials, or even replaced entirely. Although the overheat cut-off mechanism effectively mitigates combustion risks, it often leads to substantial production and equipment losses.

Furthermore, current is supplied to each temperature controller via the first electrical connectors and the second electrical connectors in the male-female configuration. Neither the first electrical connector nor the second electrical connector is equipped with an overheat protection mechanism. Consequently, if a first electrical connector or a second electrical connector becomes overheated and damaged due to excessive current flow, the corresponding heater will lose power supply. This, in turn, results in the aforementioned issues of material deposition or blockage within the pipeline.

A primary object of the present invention is to provide an electric thermal insulation equipment and a disaster prevention and warning system thereof.

To achieve the foregoing object, the present invention provides an electric thermal insulation equipment, comprising an electric thermal insulation system including a plurality of electric thermal insulation units and a plurality of temperature controllers, wherein each electric thermal insulation unit includes an insulating housing, a heat insulation structure having thermal insulation and heat isolating effects, and an electric heating structure, each insulating housing enclosing and constraining the corresponding heat insulation structure and electric heating structure, each electric heating structure being disposed on one side of the corresponding heat insulation structure, each electric thermal insulation unit being configured to enclose an outer periphery of a pipeline, and each electric heating structure being positioned between the corresponding heat insulation structure and the pipeline.

Each temperature controller being electrically connected to a corresponding electric heating structure so as to control the heating operation of the electric heating structure, each temperature controller being electrically connected to a first electrical connector and a second electrical connector, each first electrical connector being electrically connected to an adjacent second electrical connector such that the plurality of temperature controllers forms a series connection, each first electrical connector and each second electrical connector being connected to a power transmission line, each power transmission line extending through the insulating housing corresponding to the associated temperature controller, and each insulating housing constraining the respective power transmission line.

A disaster prevention and warning system is configured to monitor the electric thermal insulation system, the disaster prevention and warning system including a plurality of first thermocouples, a plurality of second thermocouples, and a human-machine interface controller, wherein each first thermocouple is disposed corresponding to a respective electric thermal insulation unit, each first thermocouple extending into the corresponding insulating housing and positioned between the corresponding heat insulation structure and the corresponding electric heating structure, each first thermocouple being coupled to the temperature controller associated with the corresponding electric thermal insulation unit such that the temperature controller determines a temperature of the electric thermal insulation unit.

Each second thermocouple having a first end disposed on a respective first electrical connector and a second end coupled to the temperature controller electrically connected to the corresponding first electrical connector, such that the temperature controller determines a temperature of the first electrical connector, each first electrical connector and each second electrical connector being connected to two first communication cables, each first communication cable being connected to a corresponding temperature controller, each second thermocouple and each first communication cable extending through the insulating housing corresponding to the associated temperature controller, and portions of each second thermocouple and each first communication cable located inside the insulating housing being disposed on a side of the heat insulation structure facing away from the electric heating structure, with each insulating housing constraining the corresponding second thermocouple and first communication cable.

The human-machine interface controller is coupled to a second communication cable, the second communication cable being coupled to each first communication cable, each temperature controller transmitting temperature values of the electric thermal insulation units and the first electrical connectors to the human-machine interface controller through the first communication cables and the second communication cable, the human-machine interface controller including a programmable controller and a warning device, the programmable controller being electrically connected to the warning device.

A temperature of each electric thermal insulation unit is defined as a first temperature value, and a temperature of each first electrical connector is defined as a second temperature value, each temperature controller transmitting the first temperature value and the second temperature value to the human-machine interface controller, the programmable controller comparing each first temperature value with a preset first warning temperature value and each second temperature value with a preset second warning temperature value, the programmable controller controlling the warning device to generate a warning signal when any first temperature value exceeds the first warning temperature value or when any second temperature value exceeds the second warning temperature value, thereby facilitating inspection and maintenance of the electric thermal insulation system and preventing stoppage of the electric thermal insulation units.

Each first electrical connector is a circular electrical connector defining a first center along a diameter direction, each second thermocouple being connected to the first center, each first electrical connector having a plurality of first crimp terminals arranged annularly and spaced apart with respect to the first center, and each power transmission line and each first communication cable being electrically connected to a respective first crimp terminal.

Accordingly, the disaster prevention and warning system performs real-time monitoring and warning of the temperatures of the electric thermal insulation units and the first electrical connectors. This prevents combustion accidents and prevents activation of the overheat cut-off mechanism caused by overheating of the electric thermal insulation units or the first electrical connectors, thereby avoiding deposition or blockage of products within the pipeline.

Each first electrical connector provides isolation protection for the connection end of the second thermocouple disposed at the first center, thereby reducing the influence of external environmental conditions on the accuracy of temperature detection of the first electrical connector by the second thermocouple.

Each insulating housing constrains the corresponding second thermocouple and first communication cable, such that each electric thermal insulation unit constitutes a pre- assembled module including the first electrical connector, the second electrical connector, the second thermocouple, and the first communication cable associated therewith. This modular configuration improves installation efficiency and facilitates convenient deployment of multiple electric thermal insulation units along the pipeline.

### BRIEF DESCRIPTION OF DRAWINGS

FIG. 1 is a cross-sectional view of an electric thermal insulation unit enclosing a pipeline in Embodiment 1 of the present invention.

FIG. 2 is a schematic diagram of a circuit architecture in Embodiment 1 of the present invention.

FIG. 3is a wiring schematic diagram of a first electrical connector, a second electrical connector, and a temperature controller in Embodiment 1 of the present invention.

FIG. 4 is a schematic diagram of a monitoring screen displayed by a warning device in Embodiment 1of the present invention.

FIG. 5 is a schematic diagram of another monitoring screen displayed by the warning device in Embodiment 1 of the present invention.

FIG. 6 is a flow chart of execution of the disaster prevention and warning system in Embodiment 1 of the present invention.

FIG. 7 is a schematic diagram of a circuit architecture in Embodiment 2of the present invention.

FIG. 8 is a wiring schematic diagram of a first electrical connector, a second electrical connector, and a temperature controller in Embodiment 2 of the present invention.

### DETAILED DESCRIPTION OF THE INVENTION

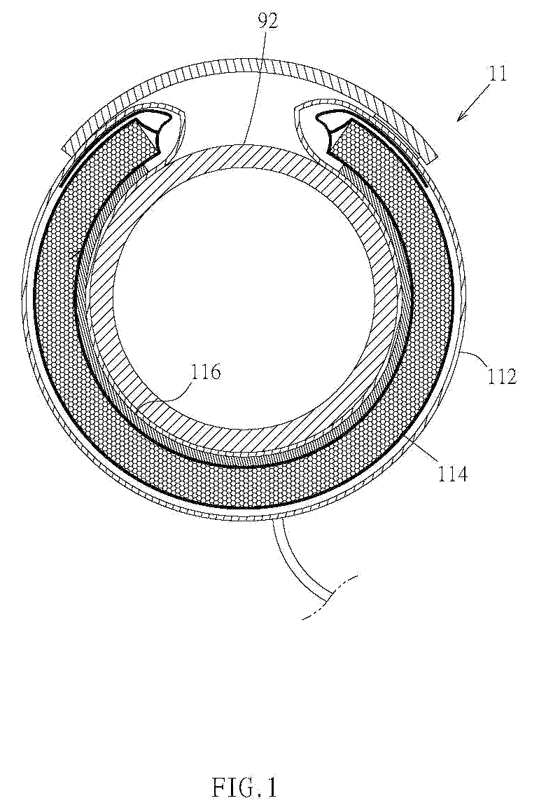

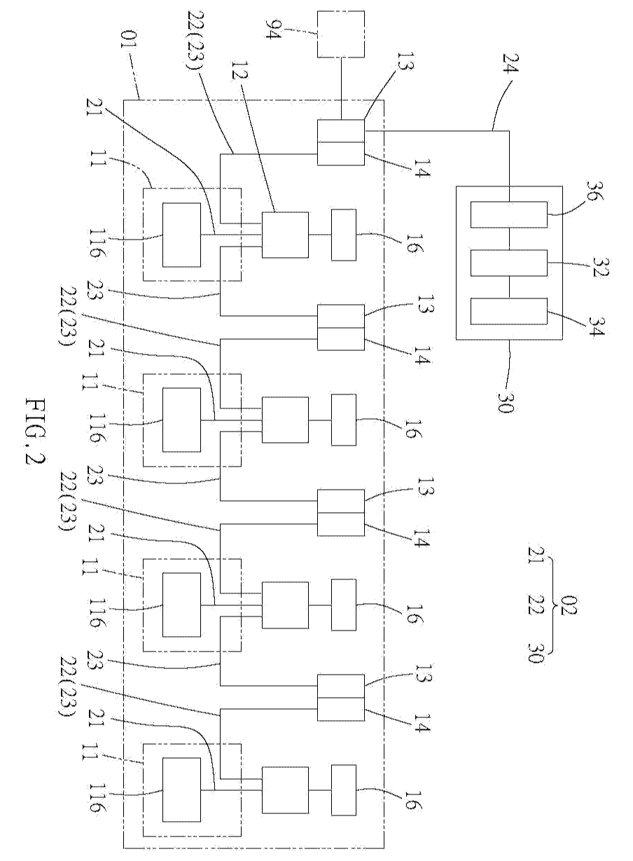

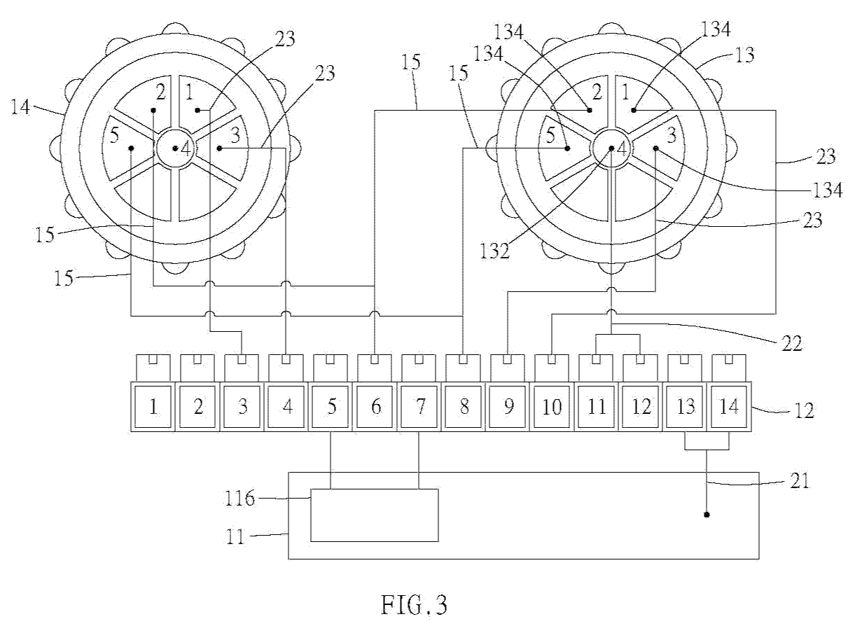

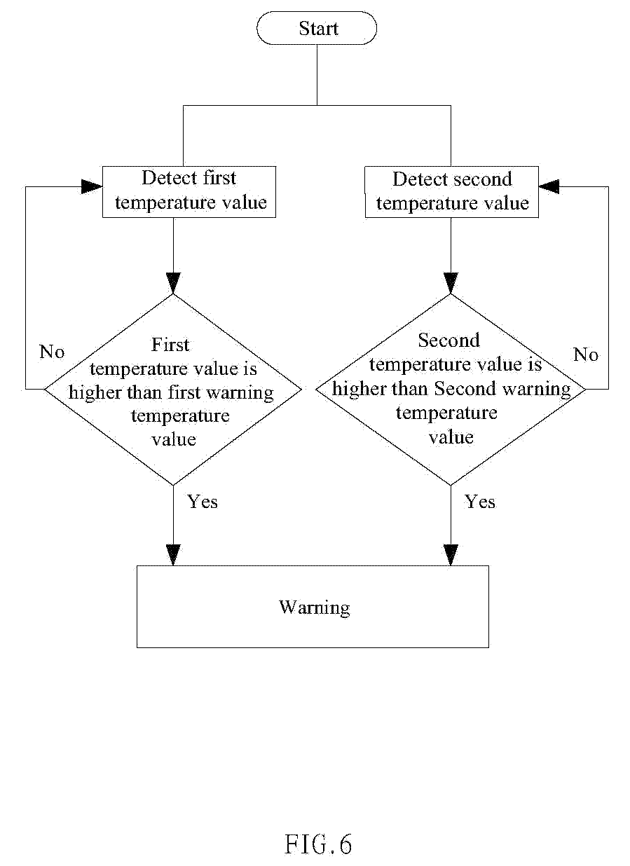

Referring to FIGS. 1 to 6, Embodiment 1 of an electric thermal insulation equipment according to the present invention comprises an electric thermal insulation system 01 and a disaster prevention and warning system 02. The electric thermal insulation system 01 supplements thermal energy dissipated from a pipeline 92 and reduces outward heat loss from the pipeline 92, while the disaster prevention and warning system 02 monitors the operation of the electric thermal insulation system 01.

The electric thermal insulation system 01 comprises a plurality of electric thermal insulation units 11 and a plurality of temperature controllers 12. Each electric thermal insulation unit 11 comprises an insulating housing 112, a heat insulation structure 114 having thermal insulation and heat-isolation properties, and an electric heating structure 116. The insulating housing 112 encloses and constrains the corresponding heat insulation structure 114 and electric heating structure 116. The electric heating structure 116 is disposed on one side of the heat insulation structure 114. Each electric thermal insulation unit 11 is configured to enclose an outer periphery of the pipeline 92, such that the electric heating structure 116 is positioned between the heat insulation structure 114 and the pipeline 92.

Each temperature controller 12 is electrically connected to the corresponding electric heating structure 116 so as to control the heat generation thereof. Each temperature controller 12 is further electrically connected to a first electrical connector 13 and a second electrical connector 14. Each first electrical connector 13 is electrically coupled to an adjacent second electrical connector 14, whereby the plurality of temperature controllers 12 forms a series connection. Each first electrical connector 13 and each second electrical connector 14 is connected to a power transmission line 15, each power transmission line 15 extending through the insulating housing 112 corresponding to the associated temperature controller 12, and each insulating housing 112 constrains the respective power transmission line 15.

An external power source 94 supplies current to each electric thermal insulation unit 11 and each temperature controller 12 via the first electrical connectors 13 and the second electrical connectors 14.

The disaster prevention and warning system 02 comprises a plurality of first thermocouples 21, a plurality of second thermocouples 22, and a human-machine interface controller 30. Each first thermocouple 21 corresponds to a respective electric thermal insulation unit 11. Each first thermocouple 21 extends into the insulating housing 112 and is positioned between the heat insulation structure 114 and the electric heating structure 116. Each first thermocouple 21 is electrically coupled to the temperature controller 12 corresponding to the electric thermal insulation unit 11, such that the temperature controller 12 determines a temperature of the electric thermal insulation unit 11.

One end of each second thermocouple 22 is mounted on a respective first electrical connector 13, while the other end is electrically coupled to the temperature controller 12 connected to the corresponding first electrical connector 13, such that the temperature controller 12 determines a temperature of the first electrical connector 13. Each first electrical connector 13 and each second electrical connector 14 is connected to two first communication cables 23, and each first communication cable 23 is electrically connected to the corresponding temperature controller 12. Each second thermocouple 22 and each first communication cable 23 extends through the insulating housing 112 corresponding to the associated temperature controller 12. The portions of each second thermocouple 22 and each first communication cable 23 located inside the insulating housing 112 are disposed on a side of the heat insulation structure 114 facing away from the electric heating structure 116.

Each insulating housing 112 constrains the corresponding second thermocouple 22 and first communication cable 23, such that each electric thermal insulation unit 11 constitutes a factory pre-assembled module comprising the first electrical connector 13, the second electrical connector 14, the second thermocouple 22, and the first communication cable 23 coupled thereto. This modular configuration enables construction personnel at an installation site of the pipeline 92 to sequentially mount the electric thermal insulation units 11 along the pipeline 92, thereby enhancing installation efficiency and operational convenience in configuring a plurality of electric thermal insulation units 11 on the pipeline 92.

The human-machine interface controller 30 is electrically connected to a second communication cable 24. The second communication cable 24 is coupled to each first communication cable 23. Each temperature controller 12 transmits temperature values of the corresponding electric thermal insulation unit 11 and first electrical connector 13 to the human- machine interface controller 30 through the first communication cables 23 and the second communication cable 24. The human-machine interface controller 30 comprises a programmable controller 32 and a warning device 34. The programmable controller 32 is electrically connected to the warning device 34.

The temperature of each electric thermal insulation unit 11 is defined as a first temperature value, and the temperature of each first electrical connector 13 is defined as a second temperature value. Each temperature controller 12 transmits the first temperature value and the second temperature value to the human-machine interface controller 30. The programmable controller 32 compares the first temperature values with a preset first warning temperature value, and the second temperature values with a preset second warning temperature value. If any first temperature value exceeds the first warning temperature value, the programmable controller 32 controls the warning device 34 to output a warning signal. If any second temperature value exceeds the second warning temperature value, the programmable controller 32 likewise controls the warning device 34 to output a warning signal.

This enables timely inspection and maintenance of the electric thermal insulation system 01, thereby preventing operational stoppage of any electric thermal insulation unit 11.

Each first electrical connector 13 is a circular electrical connector defining a first center 132 along its diameter. Each second thermocouple 22 is connected to the corresponding first center 132. Each first electrical connector 13 further comprises a plurality of first crimp terminals 134 arranged in an annular, spaced configuration with the first center 132 as the reference. Each power transmission line 15 and each first communication cable 23 is electrically connected to a respective first crimp terminal 134.

When environmental conditions such as ambient temperature, humidity, or airflow rate change in the environment where the first electrical connector 13 is located, the external surface temperature of the first electrical connector 13 may fluctuate. However, the external surface temperature does not necessarily reflect the temperature of the internal core portion of the first electrical connector 13. Since each second thermocouple 22 is connected to the first center 132 at the core of the first electrical connector 13, the portion of the first electrical connector 13 surrounding the first center 132 provides isolation protection for the connection end of the second thermocouple 22. This configuration reduces the influence of environmental variations on the accuracy of temperature sensing of the first electrical connector 13 by the second thermocouple 22. Consequently, each second thermocouple 22 is capable of more accurately detecting temperature changes at the internal core portion of the first electrical 8 connector 13, thereby enhancing the accuracy with which each temperature controller 12 determines the temperature of the first electrical connector 13.

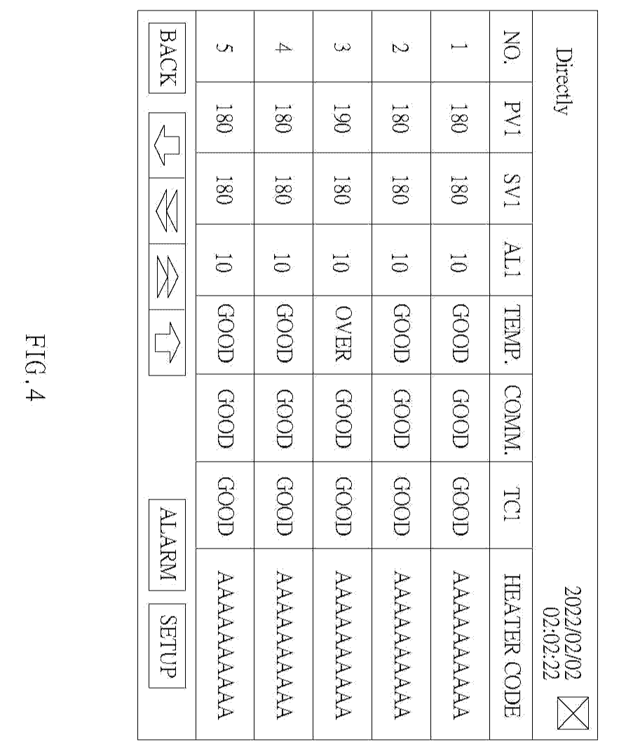

As illustrated in FIG. 4, a PV1 field displays the first temperature value, an SV1 field displays the first warning temperature value, and an AL1 field displays a range of absolute values of (PV1 - SV1) that triggers a warning signal. A temperature field displays the monitoring state of the electric thermal insulation unit 11. When the absolute value of (PV1 - SV1) is less than a set value of the AL1 field, the temperature field displays "GOOD". When the absolute value of (PV1 - SV1) is greater than the set value of the AL1 field, the temperature field displays "OVER". A communication field displays the signal transmission state between the human-machine interface controller 30 and the temperature controller 12 corresponding to the electric thermal insulation unit 11, thereby enabling monitoring of communication abnormalities. A TC1 field displays whether the temperature detection function of the first thermocouple 21 is normal or abnormal.

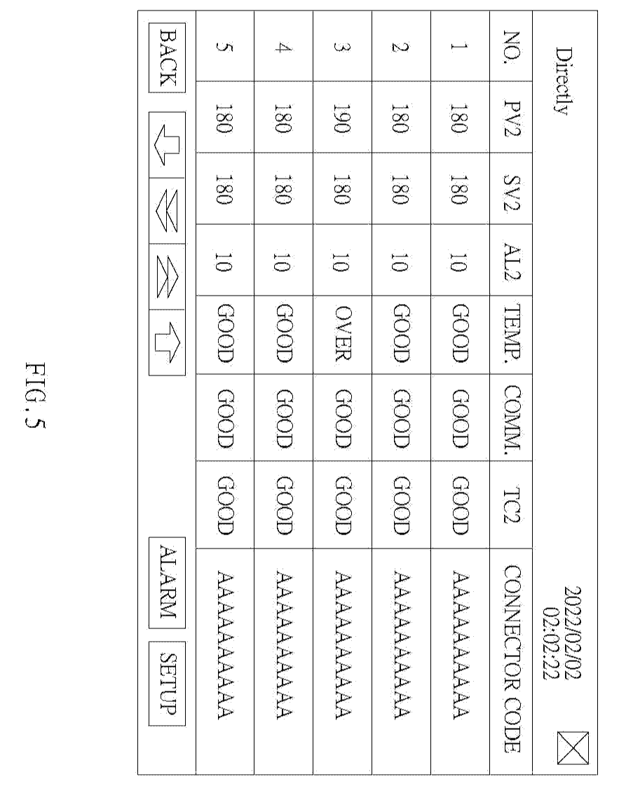

As illustrated in FIG. 5, a PV2 field displays the second temperature value, an SV2 field displays the second warning temperature value, and an AL2 field displays a range of values of (PV2 - SV2) that triggers a warning signal. A temperature field displays the monitoring state of the first electrical connector 13, while a communication field displays the signal transmission state between the human-machine interface controller 30 and the temperature controller 12 corresponding to the first electrical connector 13. A TC2 field displays whether the temperature detection function of the second thermocouple 22 is normal or abnormal.

FIGS. 4 and 5 respectively illustrate examples of monitoring screens displayed by the warning device 34, which may be switched and selected as required. The warning device 34 may alternatively be implemented as a warning unit comprising a plurality of indicator lamps (not shown), thereby constituting a variant embodiment. In such an embodiment, the monitoring personnel identify abnormal states by observing lamp colors or flashing patterns of the plurality of indicator lamps.

When the temperature of a particular electric thermal insulation unit 11 or a particular first electrical connector 13 of the electric thermal insulation system 01 is abnormal, the programmable controller 32 controls the warning device 34 to display a corresponding warning signal. Maintenance personnel can thereby promptly identify the location of the electric thermal insulation unit 11 or first electrical connector 13 exhibiting abnormal temperature and perform timely maintenance or replacement to prevent combustion events. By presetting the first 9 warning temperature value and the second warning temperature value, abnormal conditions can be addressed prior to the onset of overheating, thereby avoiding activation of the power-off mechanism. This arrangement effectively reduces the duration during which the pipeline 92 cannot receive thermal energy supplementation and prevents deposition or blockage of conveyed products within the pipeline 92.

In addition to monitoring and warning based on the electric thermal insulation units 11, the disaster prevention and warning system 02 also monitors and warns based on the second electrical connectors 14. Owing to heat conduction effects, the second temperature value detected by the second thermocouple 22 can also serve as a reference for the temperature of the second electrical connector 14 connected to the first electrical connector 13. This enables monitoring of the temperature of the second electrical connector 14, thereby preventing overheat damage to the first electrical connector 13 and the second electrical connector 14 that could otherwise interrupt power supply to the electric thermal insulation unit 11. Furthermore, this approach reduces the number of thermocouples required, thereby simplifying the associated wiring.

The human-machine interface controller 30 further comprises a communication port 36 electrically connected to the programmable controller 32. The second communication cable 24 is coupled to the communication port 36, thereby providing an interface for data transmission.

Each temperature controller 12 is further connected to a monitor 16. Each monitor 16 displays the first temperature value and the second temperature value. Accordingly, when personnel perform inspection, maintenance, or replacement of an electric thermal insulation unit 11 or a first electrical connector 13, the displayed first and second temperature values enable rapid and reliable identification of the component requiring attention. This improves both the reliability and efficiency of maintenance or replacement. Each monitor 16 may be selectively disposed in cooperation with the corresponding temperature controller 12.

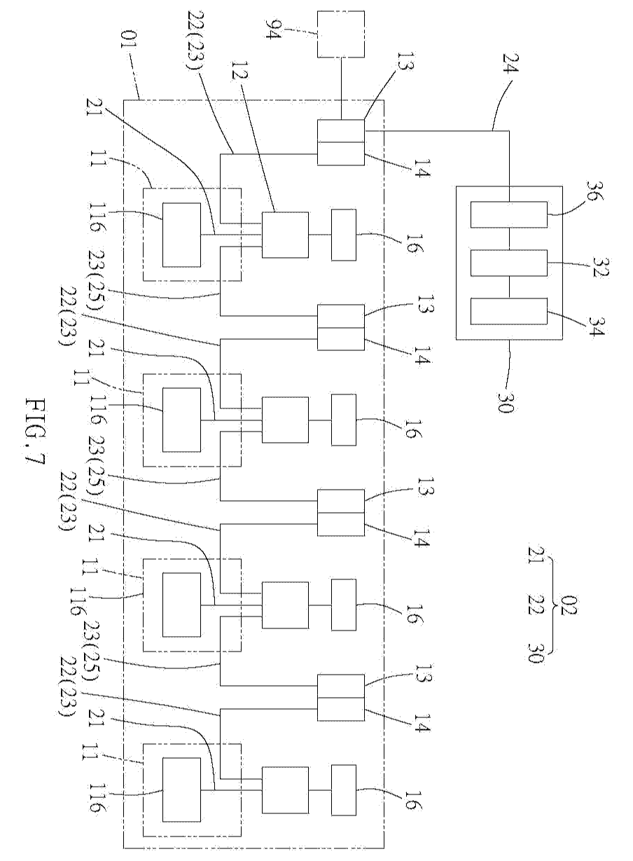

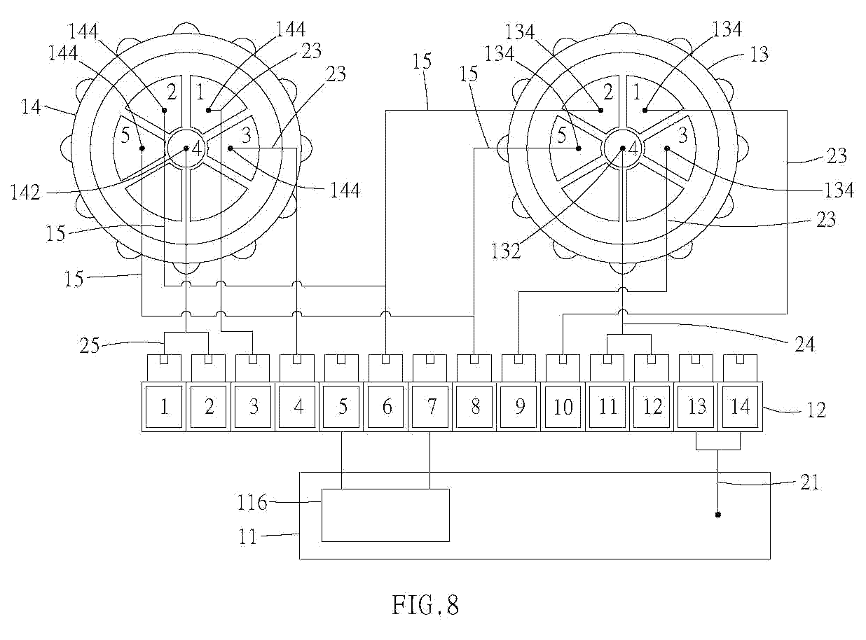

Referring to FIGS. 7 and 8, Embodiment 2 illustrates a variation of Embodiment 1. The principal distinction is that the disaster prevention and warning system 02 further comprises a plurality of third thermocouples 25. One end of each third thermocouple 25 is mounted on a respective second electrical connector 14, and the other end is electrically coupled to the corresponding temperature controller 12, such that each temperature controller 12 determines a temperature of the associated second electrical connector 14.

Each third thermocouple 25 extends through the insulating housing 112 corresponding to the temperature controller 12. The portion of each third thermocouple 25 located inside the insulating housing 112 is disposed on a side of the heat insulation structure 114 facing away from the electric heating structure 116. Each insulating housing 112 constrains the respective third thermocouple 25. Accordingly, Embodiment 2 further enhances the reliability of temperature monitoring and warning for the second electrical connectors 14.

Each second electrical connector 14 is a circular electrical connector defining a second center 142 along its diameter. Each third thermocouple 25 is connected to the corresponding second center 142. Each second electrical connector 14 further comprises a plurality of second crimp terminals 144 arranged in an annular, spaced configuration with the second center 142 as the reference. Each power transmission line 15 and each first communication cable 23 is electrically connected to a respective second crimp terminal 144.

1. An electric thermal insulation equipment, comprising:
an electric thermal insulation system including a plurality of electric thermal insulation units and a plurality of temperature controllers, wherein each electric thermal insulation unit includes an insulating housing, a heat insulation structure having thermal insulation and heat isolating effects, and an electric heating structure, each insulating housing enclosing and constraining the corresponding heat insulation structure and electric heating structure, each electric heating structure being disposed on one side of the corresponding heat insulation structure, each electric thermal insulation unit being configured to enclose an outer periphery of a pipeline, and each electric heating structure being positioned between the corresponding heat insulation structure and the pipeline;
each temperature controller being electrically connected to a corresponding electric heating structure so as to control the heating operation of the electric heating structure, each temperature controller being electrically connected to a first electrical connector and a second electrical connector, each first electrical connector being electrically connected to an adjacent second electrical connector such that the plurality of temperature controllers forms a series connection, each first electrical connector and each second electrical connector being connected to a power transmission line, each power transmission line extending through the insulating housing corresponding to the associated temperature controller, and each insulating housing constraining the respective power transmission line;
a disaster prevention and warning system configured to monitor the electric thermal insulation system, the disaster prevention and warning system including a plurality of first thermocouples, a plurality of second thermocouples, and a human-machine interface controller, wherein each first thermocouple is disposed corresponding to a respective electric thermal insulation unit, each first thermocouple extending into the corresponding insulating housing and positioned between the corresponding heat insulation structure and the corresponding electric heating structure, each first thermocouple being coupled to the temperature controller associated with the corresponding electric thermal insulation unit such that the temperature controller determines a temperature of the electric thermal insulation unit;
each second thermocouple having a first end disposed on a respective first electrical connector and a second end coupled to the temperature controller electrically connected to the corresponding first electrical connector, such that the temperature controller determines a temperature of the first electrical connector, each first electrical connector and each second electrical connector being connected to two first communication cables, each first communication cable being connected to a corresponding temperature controller, each second thermocouple and each first communication cable extending through the insulating housing corresponding to the associated temperature controller, and portions of each second thermocouple and each first communication cable located inside the insulating housing being disposed on a side of the heat insulation structure facing away from the electric heating structure, with each insulating housing constraining the corresponding second thermocouple and first communication cable;
the human-machine interface controller being coupled to a second communication cable, the second communication cable being coupled to each first communication cable, each temperature controller transmitting temperature values of the electric thermal insulation units and the first electrical connectors to the human-machine interface controller through the first communication cables and the second communication cable, the human-machine interface controller including a programmable controller and a warning device, the programmable controller being electrically connected to the warning device; and
wherein a temperature of each electric thermal insulation unit is defined as a first temperature value, and a temperature of each first electrical connector is defined as a second temperature value, each temperature controller transmitting the first temperature value and the second temperature value to the human-machine interface controller, the programmable controller comparing each first temperature value with a preset first warning temperature value and each second temperature value with a preset second warning temperature value, the programmable controller controlling the warning device to generate a warning signal when any first temperature value exceeds the first warning temperature value or when any second temperature value exceeds the second warning temperature value, thereby facilitating inspection and maintenance of the electric thermal insulation system and preventing stoppage of the electric thermal insulation units;
wherein each first electrical connector is a circular electrical connector defining a first center along a diameter direction, each second thermocouple being connected to the first center, each first electrical connector having a plurality of first crimp terminals arranged annularly and spaced apart with respect to the first center, and each power transmission line and each first communication cable being electrically connected to a respective first crimp terminal.

2. The electric thermal insulation equipment of claim 1, wherein the disaster prevention and warning system further comprises a plurality of third thermocouples, each third thermocouple having a first end disposed on a respective second electrical connector and a second end coupled to the temperature controller associated with the corresponding second electrical connector such that the temperature controller determines a temperature of the second electrical connector, each third thermocouple extending through the insulating housing corresponding to the associated temperature controller, and a portion of each third thermocouple located inside the insulating housing being disposed on a side of the heat insulation structure facing away from the electric heating structure, each insulating housing constraining the corresponding third thermocouple;
wherein each second electrical connector is a circular electrical connector defining a second center along a diameter direction, each third thermocouple being connected to the second center, each second electrical connector including a plurality of second crimp terminals arranged annularly and spaced apart with respect to the second center, and each power transmission line and each first communication cable being electrically connected to a respective second crimp terminal.

3. The electric thermal insulation equipment of claim 1, wherein the warning device is a display configured to display the first temperature value and the second temperature value, and the warning signal is a visual message.

4. The electric thermal insulation equipment of claim 1, wherein the human-machine interface controller further comprises a communication port electrically connected to the programmable controller, and the second communication cable is coupled to the communication port.

5. The electric thermal insulation equipment of claim 1, wherein each temperature controller is connected to a monitor, the monitor being configured to display the first temperature value and the second temperature value, thereby improving convenience and reliability of inspection and maintenance.

6. A disaster prevention and warning system configured to monitor an electric thermal insulation system to thereby constitute an electric thermal insulation equipment, wherein the electric thermal insulation system includes a plurality of electric thermal insulation units and a plurality of temperature controllers, each temperature controller controlling a corresponding electric heating structure to heat up and generate heat, each temperature controller being electrically connected to a first electrical connector and a second electrical connector, each first electrical connector being electrically connected to an adjacent second electrical connector such that the temperature controllers form a series connection;
the disaster prevention and warning system comprising: a plurality of first thermocouples, a plurality of second thermocouples, and a human-machine interface controller, wherein each first thermocouple is disposed corresponding to a respective electric thermal insulation unit and coupled to the temperature controller associated therewith;
one end of each second thermocouple being disposed on a respective first electrical connector and the other end being coupled to the temperature controller electrically connected to the corresponding first electrical connector, each first electrical connector and each second electrical connector being connected to two first communication cables, each first communication cable being connected to the corresponding temperature controller;
the human-machine interface controller being coupled to a second communication cable, the second communication cable being coupled to each first communication cable, each temperature controller transmitting temperature values of the electric thermal insulation units and the first electrical connectors to the human-machine interface controller through the first communication cables and the second communication cable, the human-machine interface controller including a programmable controller and a warning device, the programmable controller being electrically connected to the warning device; and
wherein a temperature of each electric thermal insulation unit is defined as a first temperature value, and a temperature of each first electrical connector is defined as a second temperature value, each temperature controller transmitting the first temperature value and the second temperature value to the human-machine interface controller, the programmable controller comparing each first temperature value with a preset first warning temperature value and each second temperature value with a preset second warning temperature value, the programmable controller controlling the warning device to generate a warning signal when any first temperature value exceeds the first warning temperature value or when any second temperature value exceeds the second warning temperature value, thereby facilitating inspection and maintenance of the electric thermal insulation system and preventing stoppage of the electric thermal insulation units;
wherein each first electrical connector is a circular electrical connector defining a first center along a diameter direction, each second thermocouple being connected to the first center, each first electrical connector having a plurality of first crimp terminals arranged annularly and spaced apart with respect to the first center, and each power transmission line and each first communication cable being electrically connected to a respective first crimp terminal.

7. The disaster prevention and warning system of claim 6, further comprising a plurality of third thermocouples, each third thermocouple having a first end disposed on a respective second electrical connector and a second end coupled to the temperature controller associated with the corresponding second electrical connector such that the temperature controller determines a temperature of the second electrical connector;wherein each second electrical connector is a circular electrical connector defining a second center along a diameter direction, each third thermocouple being connected to the second center, each second electrical connector including a plurality of second crimp terminals arranged annularly and spaced apart with respect to the second center, and each power transmission line and each first communication cable being electrically connected to a respective second crimp terminal.

8. A disaster prevention and warning system for constituting an electric thermal insulation equipment, wherein the disaster prevention and warning system is the disaster prevention and warning system as claimed in claim 1.
